(19) United States
(12) Patent Application Publication
(10) Pub. No.: US 2008/0260622 A1
(43) Pub. Date: Oct. 23, 2008

(54) Indium Tin Oxide

(75) Inventor: Derek A. Graham, Cleveland (GB)

Correspondence Address: JONES DAY, 222 EAST 41ST ST, NEW YORK, NY, 10017, US

(73) Assignee: Imperial Chemical Industries Pic, London (GB)

(21) Appl. No.: 11/597,748

(22) PCT Filed: May 24, 2005
(86) PCT No.: PCT/GB05/02065

§ 371 Date: Apr. 23, 2008

(30) Foreign Application Priority Data
May 28, 2004 (GB) 0411945.9

(51) Int. Cl. C01G 15/00; C01G 19/02

(52) U.S. Cl. 423/594.9

(57) ABSTRACT

A method of preparing indium tin oxide (ITO) and such an oxide per se are described. The method utilises a cryogenic process wherein an aqueous formulation of indium sulphate, ammonium sulphate and a tin compound, optionally in the presence of an organic polymer, are frozen to produce a solid; the solid is conditioned by heating it to cause crystallisation of water in the solid; the water is removed for example by freeze drying; and the solid is then calcined. The ITO produced may have a surface tin concentration of less than 2 and other desirable properties.

This invention relates to mixed metal oxides and particularly, although not exclusively, relates to the preparation of indium tin oxide (ITO) and such an oxide per se.

Transparent conducting oxides (TCO's), of which ITO is one of the most important, are essentially transparent to visible light but possess useful electroconductivity. In general, TCO's, and, in particular, ITO can be used to form transparent and/or conductive films, coatings, paints, and adhesives having one or more of a number or properties, including antistatic, anti rusting/corrosion, electric field/electromagnetic wave shielding, UV shielding, anti reflection, low reflective, anti streaking, improved scratch resistance, hardness, chemical resistance, and weather resistance. Among the applications in which the indium tin oxide is useful are printing electrode patterns, display devices, LC displays, touch screens, electroluminescent (EL) lamps, EMI shielding window, cathode ray tubes, architectural windows, flexible and rigid membrane switch displays, solar batteries, PDP (personal display devices), and glass security sensors.

The technology of choice for deposition of ITO (or indeed any TCO) in a manufacturing environment is d.c. magnetron sputtering using a metal or ceramic target coupled with careful control of the atmosphere. Large quantities of ITO are utilised commercially to coat polyester sheet in a vacuum roll process. This is often used as the top conducting electrode in EL-lamp displays. These typically have a sheet resistance of 50-500 Ω/□ and transparency of 80-90%. There are, however, alternative methods of depositing the clear conductive layer that offer much greater scope in the choice of substrate. This technology is based upon functional inks utilising for example screen printing to build a device in layers onto practically any substrate. There is therefore a requirement for a TCO which can be incorporated as a pigment into a binder/solvent system, which can then be printed onto a substrate and dried down to give a film with the desired electrical and optical properties.

The requirements for a TCO are a large band gap >3 eV and a conduction band shape that ensures the plasma edge lies in the infrared. Typically the host structure will allow the introduction of a large number of degenerate carriers by a combination of non-stoichiometry and alieo-valent doping. Although a great many TCO's (both p-type and n-type) are known, ITO (an n-type) is believed to have the best combination of properties and is relatively easy to synthesise.

There are various known processes for the preparation of ITO commercially. However, the ITO produced is relatively expensive. Furthermore, for some applications, ITO having different properties to that currently available is desirable.

It is an object of the present invention to address the above-described problems.

According to a first aspect of the present invention, there is provided a process for preparation of ITO which includes the steps of:
(a) causing a liquid formulation which includes a solvent to form a solid, wherein the formulation includes:
   (i) an indium compound, a tin compound and ammonium sulphate; or
   (ii) (NH₄)In(SO₄)₂ and a tin compound;
(b) conditioning the solid;
(c) causing removal of solvent from the solid prepared in (b);
(d) calcining the solid after step (c) thereby to produce ITO.

The liquid formulation of step (a) is preferably an aqueous formulation. Thus said formulation preferably includes a major amount of water as solvent.

In the context of the present specification, a “major amount” means that at least 70 wt %, suitably at least 80 wt %, preferably at least 90 wt %, especially at least 99 wt % of a specified material is present.

The solvent of step (a) preferably consists essentially of water.

The liquid formulation of step (a) is preferably at a temperature of greater than 0° C., more preferably greater than 5° C., especially at ambient temperature prior to it being caused to form a said solid.

Step (a) preferably includes causing the liquid formulation to cool, suitably to a temperature which is at or below the freezing point of the liquid formulation. Suitably, the liquid formulation is introduced into a low temperature environment which is at a temperature of less than −25° C., preferably less than −50° C., more preferably less than −100° C., especially less than −150° C. Said environment may be at ambient pressure.

Said environment may comprise a low boiling liquid at the temperature stated. Said low boiling liquid is preferably inert and/or unreactive towards any part of the formulation. Said liquid preferably comprise a material that is gaseous at STP. Said liquid preferably comprise liquid nitrogen, for example boiling liquid nitrogen.

In step (a), said liquid formulation is preferably caused to form particles of solid. Suitably, less than 10 wt %, preferably less than 5 wt %, more preferably less than 1 wt %, especially substantially no particles formed in step (a) and treated in step (b) have a particle size of less than 100 μm. Preferably, a major amount of said particles are in the range 100 μm to 2 mm. Alternatively, it is possible to produce particles in step (a) having a mean size of around 100 μm although such particle-size distributions are less preferred as the smaller particle sizes present may result in loss of material/handling difficulties in the subsequent steps.

Said particles are preferably caused to form in step (a) by spraying said liquid formulation into said low temperature environment. Said low pressure environment, for example said low boiling liquid, may be contained within a receptacle closed at one end or may define a column wherein the liquid formulation is atomised into a counter-current of said low boiling liquid. The particles may then be isolated by an appropriate technique. For example, when said low temperature environment is provided by a low boiling liquid, the particles may be separated by liquid being decanted or the particles may be filtered to achieve separation.

The ratio of the number of moles of indium ions in said indium compound to the number of moles of tin ions in said tin compound in said liquid formulation is suitably in the range 5 to 50, preferably 10 to 40, more preferably 15 to 30, especially 18 to 23.

The ratio of the number of moles of ammonium ions in said ammonium compound (e.g. ammonium sulphate or ammonium indium sulphate) to the number of moles of tin ions in said tin compound in said formulation is suitably in the range 5 to 50, preferably 10 to 40, more preferably 15 to 30, especially 18 to 23.

Preferably, the formulation comprises the materials of (a)(i). In this case, the ratio of the number of moles of indium ions in said indium compound to the number of moles of ammonium ions in said ammonium sulphate is suitably in the range 0.6 to 1.5, preferably 0.8 to 1.3, especially 0.9 to 1.1. Also, in this case, the ratio of the number of moles of tin ions in said tin compound to the number of moles of ammonium ions in said ammonium sulphate is suitably in the range 0.01 to 0.1, preferably 0.02 to 0.08, especially 0.03 to 0.07.

Said liquid formulation of step (a)(i) may include at least 0.4 wt % of said tin compound (and preferably less than 5 wt %, more preferably less than 3 wt %), at least 2 wt % of ammonium sulphate (and preferably less than 10 wt %, more preferably less than 7 wt %), at least 10 wt % of said indium compound (and preferably less than 30 wt %, more preferably less than 25 wt %, especially less than 20 wt %), and at least 60 wt % of solvent (especially water) (and preferably less than 80 wt %, more preferably less than 70 wt %).

Said liquid formulation of step (a)(ii) may include at least 0.4 wt % of said tin compound (and preferably less than 5 wt %, more preferably less than 3 wt %), at least 12 wt % of (NH₄)In(SO₄)₂ (and preferably less than 35 wt %, more preferably less than 30 wt %, especially less than 25 wt %) and at least 60 wt % of solvent (especially water) (and preferably less than 80 wt %, more preferably less than 70 wt %).

Said tin compound used in steps (a)(i) or (a)(ii) is preferably a Sn(II) compound. It may be tin (II) sulphate or tin (II) fluoride. Preferably, it is tin (II) sulphate.

If said liquid formulation includes more than one type of indium compound or more than one type of tin compound, the above-mentioned amounts/ratios preferably refer to the sum of the amounts of indium and tin ions in such compounds as appropriate. Preferably, however, said liquid formulation includes only a single type of indium compound and a single type of tin compound.

Preferably, the indium compound and ammonium sulphate of step (a)(i) are adapted to produce (NH₄)In(SO₄)₂. Thus, the compounds of (a)(i) may upon contact and/or reaction therebetween produce the compounds of (a)(ii).

The process of the first aspect may be carried out in the presence of oxygen scavenging means that is suitably arranged to scavenge and/or react with oxygen produced in the process, suitably to reduce the amount of oxygen that may be incorporated into the ITO prepared. As described hereinafter, oxygen may fill oxygen vacancies in the ITO and, consequently, strip electrons from a conduction band of the ITO, thereby resulting in reduced conductivity.

Said scavenging means is preferably a chemical means, for example a chemical compound which is able to react with decomposition products produced in the process, especially with such products produced in step (d). Such products may be produced by decomposition of compounds included in said formulation of step (a). Said scavenging means, or a decomposition product thereof, suitably produced in step (d), may form covalent bonds with products or intermediates produced by decomposition of compounds included in said formulation of step (a).

When compounds included in said formulation of step (a) include an indium sulphate compound (as is preferred), said scavenging means is preferably arranged to scavenge a product of sulphate decomposition that occurs in step (d). If the process of step (d) is carried out in air, then said scavenging means may also react with oxygen in air.

Said scavenging means may be arranged to form SO₂ from decomposition products produced in step (d).

Said scavenging means may be arranged to produce CO₂ from decomposition products produced in step (d).

Said scavenging means may be arranged to produce H₂O from decomposition products produced in step (d).

Said scavenging means is suitably arranged to decompose in step (d). Thus, its decomposition temperature is preferably less than the temperature at which calcination is carried out in step (d).

The amount of scavenging means in said formulation may be 0.9 to 2 times the amount required to fully reduce the products of the decomposition of indium sulphate to indium oxide. The amount may be 1.1 to 1.8 times, preferably 1.3 to 1.7 times, more preferably 1.4 to 1.6 times, especially about 1.5 times the amount required as aforesaid.

The amount of scavenging means may be 0.9 to 2 times the mole equivalents of indium sulphate in said formulation. The amount may be 1.1 to 1.8 times, preferably 1.3 to 1.7 times, more preferably 1.4 to 1.6 times, especially about 1.5 times the amount described as aforesaid.

Said scavenging means is suitably a polymeric material and is preferably an organic polymeric material. Said polymeric material preferably includes a repeat unit which consists of atoms selected only from carbon, hydrogen, oxygen and nitrogen atoms. Said repeat unit preferably consists of the aforementioned atoms.

Said polymeric material preferably has a molecular weight in the range 5000 to 100000 amu, more preferably in the range 5000 to 50000 amu.

Said polymeric material preferably has a Tg of at least 25° C., preferably at least 75° C., more preferably at least 125° C. The Tg may be less than 400° C., preferably less than 200° C.

Said polymeric material is preferably water soluble. Preferably, at least a 20 wt %, more preferably at least a 40 wt %, especially at least a 50 wt % solution of said polymeric material in water at 25° C. can be prepared.

Said polymeric material is preferably completely water miscible at 25° C.

Said polymeric material is preferably wholly soluble in 0.25 molar indium sulphate solution at 25° C.

Said polymeric material may include a —NH₂ moiety in its repeat unit. Said polymeric material preferably includes an amide moiety in its repeat unit. Said polymeric material is preferably an acrylamide.

Said liquid formulation of step (a) of the method preferably includes said scavenging means.

Said scavenging means is preferably dissolved in said liquid formulation selected for treatment in step (a) of the method. Each of the compounds of step (a)(i) and (ii) selected for treatment in step (a) are preferably in solution in said liquid formulation.

Said liquid formulation of step (a)(i) or (ii) may include at least 1 wt %, preferably at least 2 wt % (and preferably less than 5 wt %, more preferably less than 4 wt %) of said polymeric material.

Said liquid formulation used in step (a) is preferably substantially homogenous.

The solid prepared in step (a) suitably includes the compounds of (a)(i) or (ii), preferably (NH₄)In(SO₄)₂, optional scavenging means and frozen solvent, especially water, included initially in said liquid formulation of step (a).

In said conditioning step (b), a part of the solid is preferably caused to undergo a change, for example a physical change. Preferably, in step (b), the crystallinity of the solid is changed. Preferably, conditioning is arranged to increase the crystallinity of at least a component of said solid. Preferably, conditioning is arranged to increase the crystallinity of the solvent, especially water. Initially, the solvent, in admixture with the other components, may be in a relatively amorphous state. Conditioning is preferably arranged to increase its crystallinity. Preferably, said solvent is substantially crystalline after said conditioning. Said conditioning may comprise devitrification of said solid.

Step (b) may include raising the temperature of the solid (suitably by at least 5° C., preferably by at least 10° C.). Preferably, the difference between the lowest temperature to which the solid is subjected in step (a) compared to the highest temperature to which it is subjected in step (b) is at least 50° C., more preferably at least 100° C. Preferably, conditioning includes raising the temperature of the solid prepared in step (a); and maintaining the solid at a raised temperature for at least 5 minutes, preferably at least 15 minutes, more preferably at least 25 minutes. Step (b) may include raising the temperature in steps. It may be raised to a first raised temperature and held at the temperature; and subsequently raised to a second temperature and held at the temperature. Preferably in step (b), the maximum temperature attained by the solid is less than 0° C., more preferably less than −10° C., especially less than −20° C.

Step (b) preferably comprises annealing the solid.

Step (c) preferably includes causing vaporisation, preferably sublimation of the solvent. The step preferably includes applying energy, for example heat, to provide the latent heat of vaporisation of the solvent.

Step (c) is preferably carried out at less than ambient pressure. It may be carried out at a pressure of less than 100 Pa, preferably at less than 50 Pa, more preferably at less than 20 Pa, suitably in a vacuum. Step (c) may be carried out at 10-20 Pa.

Step (c) is suitably carried out at a shelf temperature of greater than 5° C., preferably greater than 15° C., more preferably greater than 20° C. Step (c) is preferably carried out wholly at a shelf temperature of less than 80° C., more preferably less than 60° C.

Step (c) may involve raising the temperature of the solid of step (b), suitably gradually and in a vacuum; holding the solid at the raised temperature, suitably for at least one hour; raising the temperature further and holding the solid at the raised temperature, suitably for at least 1 hour, preferably at least 10 hours. Preferably, after step (c), the solid includes less than 1 wt %, more preferably substantially no, solvent, for example water

Step (d) preferably includes subjecting the solid to an environment wherein the temperature is at least 400° C., preferably at least 600° C., more preferably at least 800° C. The temperature may be less than 1200° C., preferably less than 1000° C. Suitably, the solid is subjected to a temperature in the range 400° C. to 1200° C. (more preferably 800° C. to 1000° C.) for at least 10, preferably at least 20 minutes. It is preferably held at a temperature within said ranges for less than 1 hour.

Preferably, the solid is calcined in an inert gas atmosphere, for example in a nitrogen atmosphere.

The ITO produced in the process preferably has a powder resistivity in the range 0.1 to 0.5 Ω.cm, more preferably in the range 0.2 to 0.5 Ω.cm measured at less than 30% volume fraction, more preferably when measured at less than 25% volume fraction. The BET surface area may be less than 35m²/g, suitably less than 30m²/g, preferably less than 25m²/g, more preferably less than 20m²/g, especially 17m²/g or less. The BET surface area may be at least 10 m²/g.

Advantageously, it has been observed by X-ray Photoelectron Spectroscopy (XPS) of the surface of the ITO powder prepared in the method that the tin and indium are more evenly distributed, leading to a relatively small increase in the surface tin concentration compared to the theoretical surface tin concentration for ITO with tin and indium distributed entirely homogenously.

Thus, according to a second aspect of the invention, there is provided ITO powder having a surface tin concentration in moles per unit volume not more than twice the bulk tin concentration in moles per unit volume.

The surface tin concentration is preferably measured by XPS. It suitably refers to the ratio of the measured tin concentration at the surface to the tin concentration that is nominally in the formulation. The surface tin concentration may be not more than 1.7, is suitably not more than 1.6, is preferably not more than 1.5, is more preferably not more than 1.4, and, especially, is not more than 1.35.

The ITO powder may include a trace amount of sulphur. This may be measured by XPS. The amount of sulphur may be at least 0.1 mole %, at least 0.5 mole % or even at least 1 mole %. The amount of sulphur at the surface measured by XPS is preferably less than 3 mole %, more preferably less than 2 mole %, especially less than 1.5 mole %.

The ITO of the second aspect may have any feature of the ITO described according to said first aspect.

Another way of characterising the ITO described herein is in the terms of % enrichment measured as described in Example 9. Thus, in a third aspect, the invention provides ITO powder having a % surface tin enrichment of less than 70%, suitably less than 60%, preferably less than 50%, more preferably less than 40%, especially less than 35%.

The ITO of the third aspect may have any feature of the ITO of the first and second aspects.

The invention extends to a paint, ink or resin comprising ITO as described in any preceding aspect.

A particular application for ITO as produced by the method of the present invention or as defined in any preceding aspect is in various optical display devices, including electroluminescent (EL) lamps. EL lamps are thin, electrically stable multilayer devices that generally consist of front and rear electrodes and phosphor and dielectric layers located between the electrode layers. The front electrode is an actual conductive substrate that is screen or rotary screen-printed and may comprise the ITO on a polyester film. In early EL lamps the plates consisted of glass and ceramic, but have evolved into the thin plastic films that are commonly utilized today. The multi-layer structure of the EL lamp requires that the phosphor be excited with an alternating current to generate the field effect to energize the phosphor so causing it to emit light. In order to allow the light generated by the phosphor to escape, the front electrode containing the ITO must be at least semi-transparent. EL lamps are utilized in a wide variety of applications, including watches, pagers, membrane keyboards, sports shoes, safety vests, point of sale signs, vehicles, aircraft and military equipment.

Accordingly, the invention also extends to an electroluminescent lamp comprising ITO made by the method according to the invention or comprising ITO as described in any preceding aspect.

Any feature of any aspect of any invention or embodiment described herein may be combined with any feature of any aspect of any other invention or embodiment described herein mutatis mutandis.

Specific embodiments of the invention will now be described, by way of example, with reference to the accompanying drawings, in which:

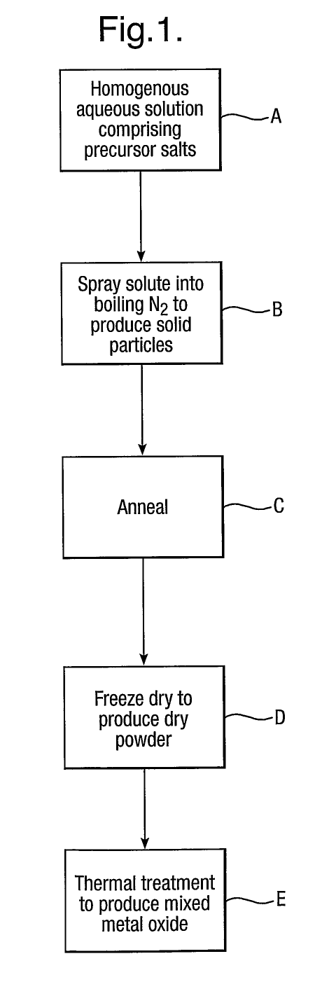

FIG. 1 is a schematic summary of steps in the preparation of indium tin oxide (ITO);

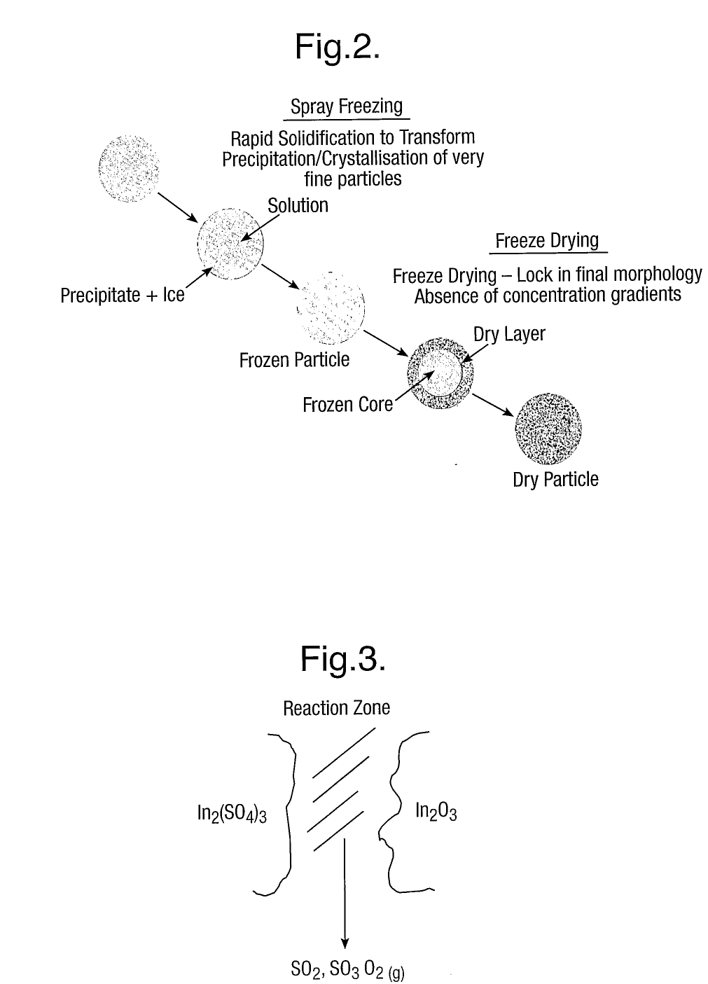

FIG. 2 is an outline of key steps in cryogenic processing of a formulation adapted to produce ITO;

FIG. 3 is a schematic representation of a solid-solid transformation of indium sulphate;

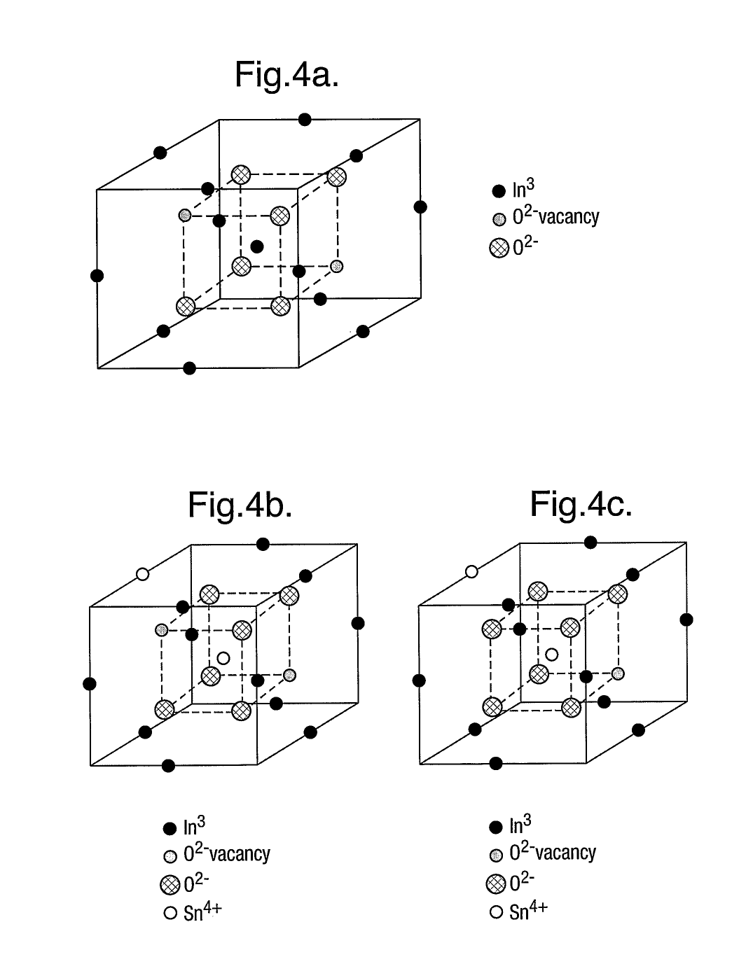

FIGS. 4a to 4c show the structure of In₂O₃, In₂O₃ doped with tin and an ITO structure with oxygen vacancies filled;

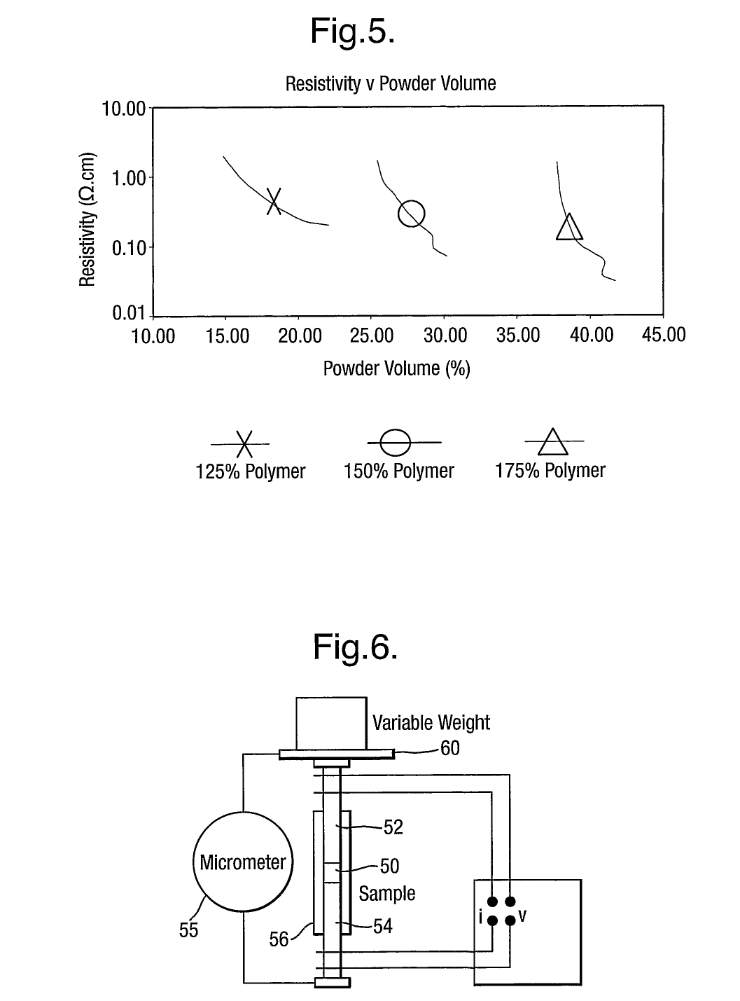

FIG. 5 illustrates the effect of added polymer on powder resistivity for three levels of polymer additions;

FIG. 6 is a schematic representation of apparatus for measuring conductivity.

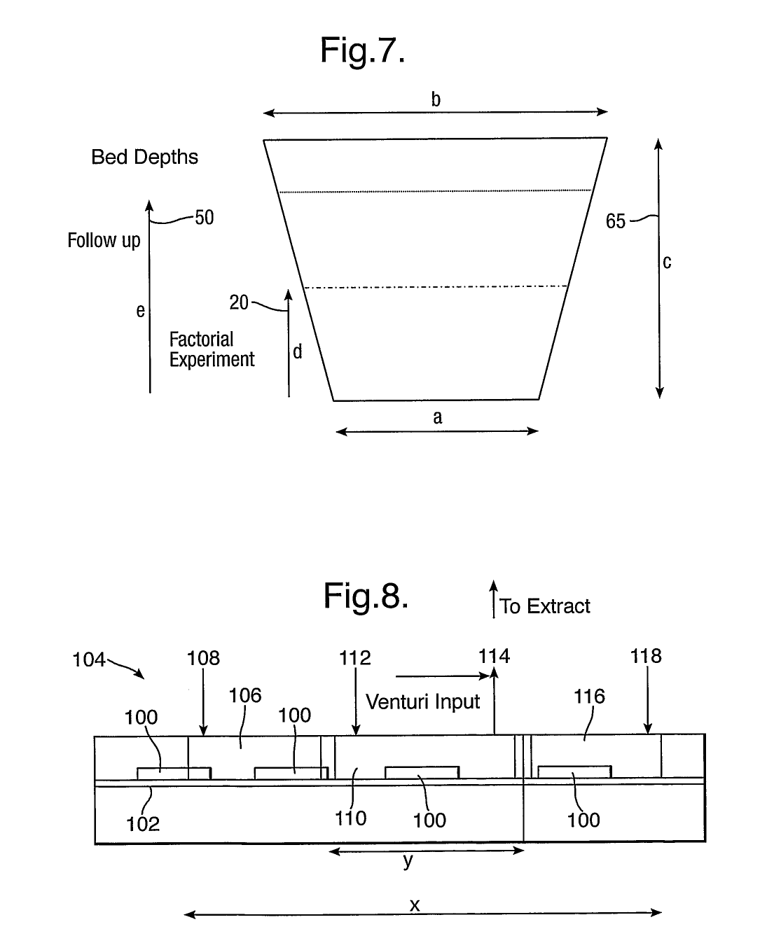

FIG. 7 is a schematic representation of a crucible; and

FIG. 8 is a schematic representation of a continuous belt furnace.

Cryogenic processing or a freeze-drying method is used to synthesise a highly transparent and low resistivity indium tin oxide (ITO) powder that may be used in screen printable inks. In broad terms, the process comprises spraying a homogeneous aqueous precursor solution, comprising salts adapted to produce ITO in the process, by atomisation into liquid nitrogen or a cold gas whereupon the droplets formed are rapidly frozen. The droplets are conditioned by annealing and then freeze dried to remove frozen ice by sublimation leaving behind a molecular mixture of the precursor salts as a dry powder. This mixture is then subjected to a thermal treatment to effect a transformation to the desired mixed metal oxide ITO.

The process is described in detail below, with reference to the summary in FIG. 1.

The precursor salts selected for step (A) of the process must have high solubility in water; be capable of being freeze dried in step (D) at conventional shelf temperatures (0-50° C.) and pressures (100-500 mbar); and be capable of being calcined in step (E) to yield ITO without melting which would destroy the structure generated during freezing (step (B)) and annealing (step (C)) processes. It has been found that indium salts such as InCl₃, In(NO₃)₃ and In₂(SO₄)₃ alone collapse if they are freeze dried at temperatures above around −30° C. (due to liquification of water in the structure) which makes their use potentially time-consuming and expensive. However, it has been found that the addition of ammonium sulphate to the aqueous formulation in step (A) results in formation of a solution of (NH₄)In(SO₄)₂ which can be freeze dried at a desired temperature in a reasonable time scale. Thus, in the formulation of step (A), the indium compound is provided by inclusion of ammonium sulphate together with an indium salt, in particular indium sulphonate (NH₄)In(SO₄)₂.

Similarly, tin in higher valence states, such as SnCl₄, is prone to collapse during freeze-drying and, additionally, the use of halides is undesirable because of potential for corrosion of the furnace during step (E). It has been found that the tin dopant can be successfully introduced using SnSO₄ as a precursor. A less preferred alternative is tin (II) fluoride (SnF₂).

In a preferred embodiment, the formulation used in step (A) comprises In₂(SO₄)₃ and ammonium sulphate (which produce In(NH₄)(SO₄)₂) together with SnSO₄.

In step (B), the formulation prepared in step (A) is sprayed by atomisation into liquid nitrogen whereupon drops are rapidly frozen to yield small intimately mixed particles of the precursor salts with ice crystals. The cryogenic processing described essentially uses phase transformations to generate fine microstructure. The key steps in the process are illustrated in FIG. 2. Very high super-cooling is used as the driver for phase separation. A major feature therefore, is that creation of the particle is not governed by chemistry or mixing but by temperature and cooling rate that may be more reproducible and easier to control. Ultimately complete freezing leads to the formation of a new solid phase that is an intimate mixture (usually on a molecular level) of the starting precursors. This in turn is mixed with ice crystals on a microscopic level leading to the formation of fine microstructure. This mixing at different levels ultimately leads to the formation of ITO that is different to ITO made by other known means.

As described above, some salts may collapse when freeze dried in step (D) and this is undesirable, since particles prepared may then be difficult to re-disperse. The origin of the collapse is that during freezing in step (B) all or part of the ice fails to crystallise but forms a vitreous glass. As a consequence, during freeze drying there comes a point when the frozen structure liquefies and falls apart, leading to collapse of the structure formed by the precursor salts.

To obviate the risk of collapse, step (C) is undertaken, wherein the frozen particles prepared in step (B) are subjected to low temperature annealing by conditioning the frozen powder at temperatures between −30 to −20° C. for 30 minutes to 2 hours. The higher the temperature of annealing, the shorter the annealing time required. It has been shown, by Isothermal DSC, that this treatment causes glassy parts of the frozen particles to crystallise, wherein water is transformed to ice and possibly, although not necessarily, there may be recrystallisation of the solute. This transition is called devitrification which occurs at a temperature in the range −35° C. to −20° C. and is accompanied by a release of heat. Devitrification results in removal of water from the glassy parts of the frozen particles with the net result that the Tg of the frozen particles is raised, making sublimation of the ice in step (D) possible without collapse.

An alternative, but much less preferred embodiment, involves storing the frozen particles of step (b) at low temperature for a long time. However, whilst crystallisation of water is thermodynamically favoured, it is kinetically very slow at low temperatures.

In step (D), the frozen crystalline water is removed without disruption of the newly created morphology. This is achieved by sublimation of the solvent phase in a process called lyopholisation or, from an engineering perspective, freeze-drying. By converting the solvent phase directly to vapour without a liquid intermediate ensures minimal disruption of the solid phase i.e. capillary pressures and secondary growth are avoided. The net result is almost perfect preservation of the solid phase morphology.

Freeze-drying may be undertaken at a temperature in the range 0 to 50° C. and a pressure in the range 100-500 mbar. In general terms, free-drying is undertaken under conditions such that the material treated does not melt (which may be a possibility if the freeze drying temperature is too high).

In step (E), the freeze dried In(NH₄)(SO₄)₂/SnSO₄ material is subjected to a thermal treatment which comprises calcination in a furnace at a temperature in the range 800 to 1000° C. at ambient pressure. The thermal decomposition of the In(NH₄)(SO₄)₂ has been shown by DSC to take place in three steps. The first starts below 100° C. and is completed by 200° C. and comprises removal of bound water. Next, at 300° C., the thermal decomposition of ammonium sulphate begins which appears to be a three-step process; the process is completed by 600° C. At 700° C. the decomposition of indium sulphate begins and is complete by 800° C. The decomposition is believed to result in the production of the cubic phase of indium oxide, together with sulphur trioxide, sulphur dioxide and oxygen. As shown in FIG. 3, the solid-solid transformation described is believed to proceed via a gaseous interface.

In the case of tin(II)sulphate, at 350° C., DSC reveals a phase transition which is believed to be a change in its crystal structure. Thermal decomposition occurs sharply at 490° C. that is believed to be in accordance with the following equation:

SnSO₄(s)→SnO₂(s)+SO₂(g)

Thus, calcination temperatures of greater than 800° C. are required for complete decomposition. Calcination of the material can be achieved without melting.

After calcination, it has been observed that there are no XRD lines or pattern due to SnO₂ and that the normal XRD pattern for indium oxide has been slightly displaced indicating some lattice substitution of tin for indium. The colour of the mixed oxide is pale green compared to the canary yellow of indium oxide when not doped by tin. Thus, this confirms the synthesis of indium tin oxide.

The doping of the indium oxide lattice with a higher valence metal than In3+ (i.e. Sn4+) introduces electrons into the system by virtue of the charge neutrality as illustrated below using the Kroger and Vink notation:

SnO₂+In_{In}^{x}→Sn_{In}^{•}+In₂O₃+e′

As the valence band is filled, the electrons go into the conduction band (cb). Consequently, the ITO is an intrinsic n-type semi-conductor and more doping should lead to higher electrical conductivity.

FIG. 4(a) illustrates the structures of In₂O₃, which is the C2 rare earth type structure; FIG. 4(b) shows substitution of two In³⁺ ions for Sn⁴⁺ ions.

Due to the existence of oxygen vacancies as illustrated in FIG. 4, it is not inevitable that more doping will increase conductivity since in the calcination step (E) molecular oxygen produced (see FIG. 3) can fill the vacancies, as illustrated in the equation below (and in FIG. 4(c) wherein one of the oxygen vacancies has been filled with O²⁻), stripping electrons from the conduction band in the process

O₂(g)+4e′+2Vₒ^{x}→2O″ₒ

As a consequence, it is possible to prepare indium oxide which is highly doped with tin but which, nonetheless, has relatively poor (compared to other materials prepared as described herein) electrical properties.

This problem may be addressed by incorporating into the formulation used in step (A) an oxygen scavenging material which can react with excess oxygen from the sulphate decomposition according to the following equation

SO₃→SO₂+½O₂

An organic material that could be sacrificially consumed during calcination was the chosen route. The selected candidate for this was a water-soluble polymer. This is easily mixed with the precursor solution prepared in step (A) and during the cryo-processing of step (B) stays intimately mixed. Upon calcination in step (D) it combines with the SO₃ or O₂ to produce SO₂, CO₂ and H₂O. If a hypothetical carbon chain polymer is used, the following reactions may take place:

(−CH₂₋)+3SO₃→3SO₂+CO₂+H₂O

2(−CH₂₋)+3O₂→2CO₂+2H₂O

If sufficient polymer is added this should eliminate the problem and preserve the oxygen vacancies.

Preferred polymers for use as scavengers have a relatively high Tg to make the formulation for use in step (A) more handleable and are water soluble and compatible with the low pH and ionic strength of the solution used in step (A). Polyacrylic acid (PAA) and polyacrylamide (PAM)can be used.

A particularly preferred polymer is a 50 wt % polyacrylamide aqueous solution comprising polyacrylamide of molecular weight about 10,000 amu and a Tg of 140° C. This can be added directly to the formulation for use in step (A) in the desired amount and requires minimal dissolution time.

The polymer was formulated to the indium sulphate in accordance with the following equation:

5In₂(SO₄)₃+2(—CH₂CHCONH₂)→5In₂O₃+15SO₂+6CO₂+5H₂O+N₂

Thus, a ratio of 518 g (1 mole) of indium sulphate to 28.4 g (0.4 moles of the repeat unit) of polyacrylamide is just sufficient to oxygen balance the system. Note that the ammonium sulphate is not referenced in the above equation since it decomposes before the indium sulphate and so is not relevant. Tin sulphate is not referenced since it decomposes without producing O₂ or SO₃.

In order to gauge the effect of polymer addition on ITO prepared, samples were prepared with 5% mole equivalents tin and polymer in the range of 50-150% mole equivalents of oxygen balance. The samples were studied by Differential Thermal Analysis/Thermogravimetric Analysis.

It was found that with polymer present at 150% of the oxygen balance, the decomposition of the ammonium sulphate was largely unaffected; however, the indium sulphate decomposition was complete at little over 600° C. Thus, the polymer had in effect lowered the calcination temperature by about 200° C.

It has been found that addition of polymer as described fundamentally changes the nature of the decomposition. Samples were calcined at 900° C. as before and compared to those processed without polymer. The effect is quite dramatic (as illustrated in FIG. 5) with an almost ten-fold increase in the performance of the powder in the resistivity test of FIG. 6 described hereinafter. The powder resistivity is found to compare favourably with commercially available ITO but, advantageously, this can be achieved at lower powder volume fractions.

The level of polymer addition affects properties of the ITO. It is possible with a large excess of polymer to sinter the ITO giving highly conductive, low surface area dense particles. Similarly, it is possible to use less polymer and retain the fluffy, high surface area obtained without polymer addition.

The following analytical methods may be used to analyse materials prepared as described herein.

### Analytical Method 1—Measurement of Resistivitv/conductivitv and Density.

The powder electrical conductivity was measured by compacting a small sample if material and measuring the resistance of it. The arrangement for measuring the conductivity is shown in FIG. 6 and this provides a convenient and rapid means of assessing the viability of a particular powder.

The sample 50 to be tested is first weighed and inserted between two pistons 52, 54 held in place with a glass sleeve 56. A micrometer 55 is used to measure the position of a ram 60. The voltage and current are measured and displayed as a resistance (R) whilst an incrementally increasing force is applied to the sample, up to a maximum force of 5.4 MPa. The simple cylindrical geometry allows the powder resistivity (r) to be measured by the relationship

$$r = \frac{RA}{d}$$

where A is the cross-sectional area of the sample holder and d is the measured distance. The powder volume fraction is calculated from the following

$$φ = \frac{dA}{{ρ}_{o}}$$

where ρₒ is the density of crystalline indium oxide (taken as 7.1 gcm⁻³). In a typical test the resistivity as a function of powder volume fraction is plotted. This gives information not only on the electrical properties but also how compactable the material is.

### Analytical Method 2—Measurement of BET Surface Area

The BET surface area was measured by first outgassing the sample over nitrogen at 100° C. and then measuring the nitrogen sorption at liquid nitrogen temperature using a Micromeritics APSP2400.

Specific examples of the preparation of ITO are provided below.

In each of the following examples which involve calcinations in air, a frusto-conical crucible as shown in FIG. 7 was used for containing samples. This has diameters “a” and “b” of 40 mm and 78 mm respectively; and a height “c” of 65 mm.

The bed depth of material calcined in the crucibles was 20 mm-30 mm in the processes of Examples 1 to 6.

Unless otherwise stated all materials were used as received from Aldrich UK. The indium salt described was obtained from the Indium Corporation of the USA.

### EXAMPLE 1

Anhydrous indium(III) sulphate (57.5 g, 0.111 mol) was slowly added with agitation to demineralised water (240 g, 13.3 mol) at ambient temperature. Ammonium sulphate (14.75 g, 0.111 mol) and tin(II) sulphate (2.5 g, 0.012 mol) were subsequently added. Stirring was continued until a clear slightly yellow solution was obtained.

The solution was sprayed into boiling liquid nitrogen. using a drop generator, which consists of a metal plate which allows predrilled holes of variable size to be inserted. In the present example an arrangement with 5×0.5 mm holes was used. At the end of the process the excess liquid nitrogen was carefully decanted and frozen particles recovered. A narrow frozen particle size distribution with no particles below 100 μm was produced.

The frozen droplets were placed onto trays which were pre-cooled in a batch freeze dryer at −40° C. The frozen powder was spread evenly onto each tray to a bed depth of 10-15 mm.

Annealing and freeze drying were carried out in a conventional batch freeze dryer which utilises a 24 hour cycle using a fixed programme. The product was first warmed to −40° C. and held there for 30 minutes. The shelf temperature was then raised to −25° C. and held there for 1 hour to anneal the product. The temperature was then lowered to −40° C. and held for a further 10 minutes. This completed the annealing process.

A vacuum was then applied 0.13 mBar(100 mTorr) and the shelf temperature raised to 25° C. over a period of 2 hours. It was then held at this temperature for a further 4 hours. The temperature was then raised to 40° C. over a period of 2 hours and then held there until the end of the drying period (a total time of 20-24 hours). The product leaving the dryer was completely free of ice.

The dried ITO precursor was then calcined by placing material in crucibles that were then quickly placed into a muffle furnace set at 900° C. in ambient air. The product was removed from the furnace after 1 hour and allowed to cool to ambient temperature. It was observed that the initially white precursor was green after calcination and the volume of material was reduced by a factor of about three-quarters.

The resistivity at maximum load, measured in accordance with Analytical Method 1 above was 17.7 Ω.cm and the powder volume fraction was 25.8%. The BET surface area, measured in accordance with Analytical Method 2, was 12 m²/g.

The ITO produced may suitably be used as an antistatic.

### EXAMPLE 2

The same formulation and procedure as described in Example 1 was used except that at the end of the calcination step the powder was quenched by discharging the hot powder from the muffle furnace directly onto a metal tray at room temperature. The resistivity and powder volume were 5.3 Ωcm and 21.1% respectively.

### EXAMPLE 3

The following formulation was prepared by the method described in Example 2 and analysed as described in Analytical Methods 1 and 2. The resistivity and powder volume were 0.42 Ω.cm and 19% respectively.

| | |
|---|---|
| Indium(III) Sulphate | 57.5 g, 0.111 mol |
| Ammonium Sulphate | 14.75 g, 0.111 mol |
| Tin(II) Sulphate | 2.5 g, 0.012 mol |
| Water | 240 g, 13.3 mol |
| Polyacrylamide Solution* | 9.6 g, 1.5 mole equiv. |

*The polycarylamide solution comprised a 50% wt solution in water of a polymer of molecular weight 10,000 amu. 1 mole equivalent is 64 g of this solution.

### EXAMPLE 4

The same formulation as in Example 3 was used. Here the precursor solution was placed in a pressurised container and sprayed via an atomiser (1-2 bar) into a Dewar vessel containing liquid nitrogen which was agitated. Finer frozen particles (mean size 100 μm) could be prepared. The powder was analysed in accordance with Analytical Methods 1 and 2.

The resistivity and powder volume were 0.32 Ω.cm and 25% respectively.

### EXAMPLE 5

The same formulation as in Example 1 was atomised into a counter-current of cold gas in a 3 m spray tower at a temperature of −95° C. Frozen powder was removed from the bottom of the tower continuously. This was further processed as described in Example 1 and tested as in Analytical Methods 1 and 2.

The powder resistivity and volume fraction were 12.1 Ω.cm and 23% respectively. It will be appreciated that the method used produces particles which compare favourably with that produced using the method of Example 1.

### EXAMPLE 6

A formulation optimisation study was carried out to obtain the best combination of properties for use in inks. Materials of low resistivity and high surface area were sought. It has been found that smaller particles with high surface area do not scatter visible light as much as larger particles. Therefore a combination of high surface area (leading to better transparency when in an ink) and low resistivity is desirable.

The key variables identified were: tin content (or amount of doping); polymer content (essentially the amount of reduction); calcination temperature; and the concentration of solids in solution.

The levels of the variables studied were as follows:

Tin Content, 1%, 5% and 10% mole equivalents in ITO;
Polymer Content 1.25, 1.5 and 1.75× mol. equivalents of In₂(SO₄)₃

### Calcination Temperature (Tcal(° C.)) 800° C., 900° C. and 1000° C.

Concentration of Solution 20% and 33% of indium sulphate in water.

Approximately 100 g of precursor solution were prepared at each level of the formulation variables giving a total of 18 distinct solutions. Each of these was processed as described in Example 2 except for the calcination step. At this point each of the 18 dried precursor samples was divided into three separate lots. The first lot of 18 was calcined at 800° C., the next at 900° C. and finally the remainder at 1000° C. All samples had their resistivity and BET measured in accordance with Analytical Methods 1 and 2.

The data is summarised in Table 1 below.

The data was analysed and assessed. It was concluded that solution strength was of little effect on the measured variables. Low tin content yielded very poor resistivity and all examples were rejected. It was noted that some materials prepared possess, simultaneously, high surface area and low resistivity.

### EXAMPLE 7

The formulations of Example 6.22, 6.27, 6.28, 6.32, 6.46, 6.50, 6.51 and 6.52 were selected for assessment on larger scale samples (5 times scale up; 250 g samples) and such samples were prepared in accordance with the procedure in Example 2 and re-tested. The bed depth of the samples (distance “d” in FIG. 7) was 50 mm. Results are provided in Table 2 below.

Example 7.2 was prepared many times with similar properties and was chosen as the optimum formulation with 900° C. as the calcination temperature.

To optimise properties of ITO prepared it is believed to be important to consider the bed depth in product containers. If the bed depth is high and high amounts of polymer are used and calcinations are carried out at high temperature there is a risk of sintering the primary particles and, furthermore, the properties of ITO produced may be detrimentally affected. This may be explained on the basis that reducing gases are produced from the precursor during calcinations and, consequently, the ITO towards an upper end of a bed is contacted by a greater amount of this gas than would be the case in a shallower bed. Consequently, there is a greater risk of over reduction, thereby affecting properties.

TABLE 1

| | | Polymer | | | | |
|---|---|---|---|---|---|---|
| Example | Tin | (mol· | T_{cal} | Conc. | Res · | BET |
| No | (%) | equiv) | (° C.) | (%) | Ω · cm | (m²/g) |
| 6.1 | 1 | 1.25 | 800 | 20 | 797.3 | 33.3 |
| 6.2 | 1 | 1.25 | 800 | 33 | 676.5 | 29.3 |
| 6.3 | 1 | 1.25 | 900 | 20 | 6.57 | 9.8 |
| 6.4 | 1 | 1.25 | 900 | 33 | 7.7 | 13 |
| 6.5 | 1 | 1.25 | 1000 | 20 | 0.7 | <5 |
| 6.6 | 1 | 1.25 | 1000 | 33 | 2 | 5.3 |
| 6.7 | 1 | 1.50 | 800 | 20 | 291.6 | 35.2 |
| 6.8 | 1 | 1.50 | 800 | 33 | 23.2 | 25 |
| 6.9 | 1 | 1.50 | 900 | 20 | 1.08 | 7.5 |
| 6.10 | 1 | 1.50 | 900 | 33 | 1.1 | 7 |
| 6.11 | 1 | 1.50 | 1000 | 20 | 0.14 | <5 |
| 6.12 | 1 | 1.50 | 1000 | 33 | 0.2 | <5 |
| 6.13 | 1 | 1.75 | 800 | 20 | 1.48 | 10.1 |
| 6.14 | 1 | 1.75 | 800 | 33 | 1.12 | 7.4 |
| 6.15 | 1 | 1.75 | 900 | 20 | 0.49 | <5 |
| 6.16 | 1 | 1.75 | 900 | 33 | 0.36 | <5 |
| 6.17 | 1 | 1.75 | 1000 | 20 | 0.18 | <5 |
| 6.18 | 1 | 1.75 | 1000 | 33 | 0.08 | <5 |
| 6.19 | 5 | 1.25 | 800 | 20 | 33.7 | 37.9 |
| 6.20 | 5 | 1.25 | 800 | 33 | 12.1 | 38.4 |
| 6.21 | 5 | 1.25 | 900 | 20 | 1.49 | 25.6 |
| 6.22 | 5 | 1.25 | 900 | 33 | 0.7 | 22.1 |
| 6.23 | 5 | 1.25 | 1000 | 20 | 0.21 | 6.5 |
| 6.24 | 5 | 1.25 | 1000 | 33 | 0.35 | 9.9 |
| 6.25 | 5 | 1.50 | 800 | 20 | 11.5 | 42.2 |
| 6.26 | 5 | 1.50 | 800 | 33 | 3.24 | 33.1 |
| 6.27 | 5 | 1.50 | 900 | 20 | 0.42 | 16.8 |
| 6.28 | 5 | 1.50 | 900 | 33 | 0.34 | 16.3 |
| 6.29 | 5 | 1.50 | 1000 | 20 | 0.11 | <5 |
| 6.30 | 5 | 1.50 | 1000 | 33 | 0.2 | <5 |
| 6.31 | 5 | 1.75 | 800 | 20 | 0.94 | 25.5 |
| 6.32 | 5 | 1.75 | 800 | 33 | 0.77 | 33.3 |
| 6.33 | 5 | 1.75 | 900 | 20 | 0.24 | 6.7 |
| 6.34 | 5 | 1.75 | 900 | 33 | 0.15 | <5 |
| 6.35 | 5 | 1.75 | 1000 | 20 | 0.07 | <5 |
| 6.36 | 5 | 1.75 | 1000 | 33 | 0.09 | <5 |
| 6.37 | 10 | 1.25 | 800 | 20 | 9.68 | 39.1 |
| 6.38 | 10 | 1.25 | 800 | 33 | 10.57 | 42.9 |
| 6.39 | 10 | 1.25 | 900 | 20 | 1.48 | 25 |
| 6.40 | 10 | 1.25 | 900 | 33 | 1.86 | 24.8 |
| 6.41 | 10 | 1.25 | 1000 | 20 | 0.44 | <5 |
| 6.42 | 10 | 1.25 | 1000 | 33 | 0.36 | 10 |
| 6.43 | 10 | 1.50 | 800 | 20 | 3.33 | 38 |
| 6.44 | 10 | 1.50 | 800 | 33 | 0.98 | 34 |
| 6.45 | 10 | 1.50 | 900 | 20 | 0.21 | 8.4 |
| 6.46 | 10 | 1.50 | 900 | 33 | 0.23 | 12.1 |
| 6.47 | 10 | 1.50 | 1000 | 20 | 0.18 | <5 |
| 6.48 | 10 | 1.50 | 1000 | 33 | 0.22 | 10.7 |
| 6.49 | 10 | 1.75 | 800 | 20 | 0.97 | 32.1 |
| 6.50 | 10 | 1.75 | 800 | 33 | 0.38 | 29.3 |
| 6.51 | 10 | 1.75 | 900 | 20 | 0.25 | 10.7 |
| 6.52 | 10 | 1.75 | 900 | 33 | 0.25 | 12.1 |
| 6.53 | 10 | 1.75 | 1000 | 20 | 0.21 | 27.1 |
| 6.54 | 10 | 1.75 | 1000 | 33 | 0.17 | <5 |

TABLE 2

| | | | Polymer | | | | |
|---|---|---|---|---|---|---|---|
| Example | Similar | Tin | (mol · | T_{cal} | Conc | Res · | BET |
| No | Example | (%) | equiv) | (° C.) | (%) | Ω · cm | (m²/g) |
| 7.1 | 6.22 | 5 | 1.25 | 900 | 33 | 0.7 | 22.1 |
| 7.2 | 6.27 | 5 | 1.50 | 900 | 20 | 0.13 | 28 |
| 7.3 | 6.28 | 5 | 1.50 | 900 | 33 | 0.23 | 12.1 |
| 7.4 | 6.32 | 5 | 1.75 | 800 | 33 | 0.51 | 18.2 |
| 7.5 | 6.46 | 10 | 1.50 | 900 | 33 | 0.81 | 21.6 |
| 7.6 | 6.50 | 10 | 1.75 | 800 | 33 | 0.27 | 18.7 |
| 7.7 | 6.51 | 10 | 1.75 | 900 | 20 | 0.16 | 5 |
| 7.8 | 6.52 | 10 | 1.75 | 900 | 33 | 0.25 | 5 |

### EXAMPLE 8

The following formulation was prepared by using the method of Example 1 as far as the freeze drying stage. Calcination was carried out as follows: alumina trays were used to hold the precursor for the calcination step. 50 g of precursor was placed in each tray 100 (FIG. 8) and placed on the belt 102 of a tunnel furnace 104 which consisted of three zones, as shown in FIG. 8. In the first zone 106 there was no heating; the product passes into this zone via a nitrogen curtain 108. The product then enters the hot zone 110 which is a metal muffle controlled at 900° C. and a cover gas of nitrogen 112 is used. Exhaust gases are removed via a venturi 114. After the heating zone the product tray passes into a cooling zone 116 using circulating water to remove heat from the product. Nitrogen 118 is again used as a cover gas. Typically, distance x is 3.4 m, distance y is 1.4 m and the belt speed is 5 cm/minute.

The product ITO emerges from the cooling zone 116 below 50° C. and can be transferred directly to containers.

The powder properties were assessed in accordance with Analytical Methods 1 and 2.

| | |
|---|---|
| Indium(III) Sulphate | 575 g (1.11 mol) |
| Ammonium Sulphate | 147.5 g (1.11 mol) |
| Tin(II) Sulphate | 25 g (0.12 mol) |
| Polacrylamide Solution | 86 g (1.34 mol. equiv) |
| Water | 2400 g (133.3 mol) |

The powder resistivity was 0.25 Ω.cm at a powder volume of 25%. The BET surface area was 15 m²/g.

### EXAMPLE 9

Samples of ITO were prepared in accordance with the method of Example 8 using tin concentrations of 1 mol % (Example 9a), 5 mol % (Example 9b) and 10 mol % (Example 9c) of the indium concentrations.

These samples and two commercially available ITO samples (Examples CA1 and CA2) were analysed by X-ray photoelectron spectroscopy (XPS) to assess the surface tin and surface sulphur concentrations. Results are provided in Table 3 below.

TABLE 3

| | Sn/In Nominal | Sn/In XPS | | |
|---|---|---|---|---|
| Example No | (mole %) | (mole %) | % Enrichment | Smole % |
| 9a | 1.0 | 1.37 | 37% | 1.4 |
| 9b | 5.0 | 6.74 | 35% | 1.2 |
| 9c | 10.0 | 12.91 | 29% | 1.1 |
| CA1 | 1.0 | 2.0 | 100% | 0 |
| CA2 | 10.0 | 17.3 | 73% | 0 |

Table 3 details the mole % surface enrichment of the ITO that is calculated according to the following equation:

% enrichment=[100(Sn/InXPS(mole %)+(Sn/In Nominal(mole %))]-100% (Measured mole %-Nominal mole %)×100/(Nominal Mole %)

Sn/InXPS refers to the surface tin to indium ratio measured by XPS.

It will be appreciated that the lower the % enrichment, the more desirable the ITO may be.

It will be noted also that the presence of sulphur may also be used to distinguish the ITO produced by the method described from that produced by other methods.

### EXAMPLE 10

Samples (A series) of EL lamps were prepared using the ITO prepared as described in Example 8, while a second, comparative set (B series) were prepared using the ITO L-1469-2, commercially available from Mitsubishi. The results of testing on these samples are shown in Table 4.

TABLE 4

| | Light Output | Amperage Draw | | |
|---|---|---|---|---|
| Sample | (Cd/m2) | (Milliamps) | Colour-Co(x-y)¹ | LAR² |
| A1 | 90.5 | 3.21 | 0.202-0.475 | 28.19315 |
| A2 | 95.2 | 3.31 | 0.202-0.475 | 28.76133 |
| A3 | 94.7 | 3.30 | 0.202-0.476 | 28.69697 |
| B1 | 28.2 | 1.28 | 0.193-0.433 | 22.03125 |
| B2 | 34.1 | 1.30 | 0.193-0.432 | 26.23077 |
| B3 | 31.2 | 1.26 | 0.192-0.432 | 24.76190 |

¹Measured using the 1931 CIE standard.
²LAR is light output divided by amperage draw.

As shown in Table 4, the EL lamps containing the indium tin oxide of the present invention provide superior light output and other properties than the EL lamps containing the commercially available indium tin oxide.

1. A process for the preparation of indium tin oxide (ITO) which includes the steps of:
(a) causing a liquid formulation which includes a solvent to form a solid, wherein the formulation includes:
(i) an indium compound, a tin compound and ammonium sulphate; or
(ii) (NH₄)In(SO₄)₂ and a tin compound;
(b) conditioning the solid;
(c) causing removal of solvent from the solid prepared in (b);
(d) calcining the solid after step (c) thereby to produce ITO.

2. A process according to claim 1, wherein said liquid formulation of step (a) is an aqueous formulation.

3. A process according to claim 1, wherein the ratio of the number of moles of indium ions in said indium compound to the number of moles of tin ions in said tin compound in said liquid formulation is in the range 5 to 50; and the ratio of number of moles of ammonium ions in said ammonium compound to the number of moles of tin ions in said tin compound in said formulation is in the range 5 to 50.

4. A process according to claim 1, which comprises the materials of (a)(i), wherein the ratio of the number of moles of indium ions in said indium compound to the number of moles of ammonium ions in said ammonium sulphate is in the range 0.6 to 1.5; and the ratio of the number of moles of tin ions in said tin compound to the number of moles of ammonium ions in said ammonium sulphate is in the range 0.01 to 0.1.

5. A process according to claim 1, wherein said liquid formulation of step (a)(i) includes at least 0.4 wt % of said tin compound, at least 2 wt % of ammonium sulphate, at least 10 wt % of said indium compound and at least 60 wt % of solvent.

6. A process according to claim 1, wherein said tin compound used in steps (a)(i) or (a)(ii) is a Sn(II) compound.

7. A process according to claim 6, wherein said tin compound is tin (II) sulphate.

8. A process according to claim 1, which is carried out in the presence of oxygen scavenging means which is arranged to scavenge and/or react with oxygen produced in the process to reduce the amount of oxygen that may be incorporated into the ITO prepared.

9. A process according to claim 8, wherein said scavenging means is a chemical compound which is able to react with decomposition products produced in step (b) of the process.

10. A process according to claim 8, wherein said scavenging means is a water-soluble polymeric material.

11. A process according to claim 10, wherein the amount of scavenging means in said formulation is 0.9 to 2 times the amount required to fully reduce the products of the decomposition of indium sulphate to indium oxide.

12. A process according to claim 1, wherein step (a) includes causing the liquid formation to cool to a temperature which is at or below the freezing point of the liquid formulation.

13. A process according to claim 1, wherein in step (a) the liquid formulation is introduced into a low temperature environment which is at a temperature of less than −25° C.

14. A process according to claim 1, wherein in step (a) the liquid formulation is caused to form particles of solid.

15. A process according to claim 14, wherein less than 10 wt % of the particles formed in step (a) and treated in step (b) have a particle size of less than 100 μm.

16. A process according to claim 14, wherein a major amount of the particles are in the range 100 μm to 2 mm.

17. A process according to claim 1, wherein in said conditioning step (b) a part of the solid is caused to undergo a physical change.

18. A process according to claim 1, wherein in said conditioning step (b) the crystallinity of the solvent is increased.

19. A process according to claim 1, wherein in step (b), the temperature of the solid is raised by at least 5° C.

20. A process according to claim 1, wherein step (c) includes causing sublimation of the solvent.

21. A process according to claim 1, wherein step (d) includes subjecting the solid to an environment wherein the temperature is at least 400° C. and is less than 1200° C.

22. A process according to claim 1, wherein the ITO produced in the process has a powder resitivity in the range 0.1 to 0.5 Ω.cm measured at less than 30% volume fraction; and a BET surface area of less than 35 m2/g.

23. Indium tin oxide (ITO) powder having a surface tin concentration in moles per unit volume not more than twice the bulk tin concentration in moles per unit volume.

24. Indium tin oxide (ITO) powder having a % surface tin enrichment of less than 70%.

25. ITO according to claim 23, which includes a trace of sulphur.

26. ITO according to claim 23, which includes at the surface 0.1 to 3 mole % of sulphur.

27. ITO according to claim 23, having a powder restitivity in the range 0.1 to 0.5 Ω.cm measured at less than 30% volume fraction.

28. ITO according to claim 23, wherein the BET surface area is less than 35 m2/g.

29. A paint, ink or resin incorporating ITO made in a process according to claim 1.

30. An electroluminescent lamp comprising ITO made by the process according to claim 1.

31. An electroluminescent lamp comprising ITO as claimed in claim 23.

32. A process, indium tin oxide, a paint, ink or resin and an electroluminescent lamp, each being independently substantially as hereinbefore described with reference to the examples.
